(19) United States
(12) Patent Application Publication
(10) Pub. No.: US 2011/0316835 A1
(43) Pub. Date: Dec. 29, 2011

(54) DISPLAY DEVICE

(75) Inventors: Ryota MIZUTANI, Kanagawa (JP); Naoki HIJI, Kanagawa (JP)

(73) Assignee: FUJI XEROX CO., LTD., Tokyo (JP)

(21) Appl. No.: 12/986,523

(22) Filed: Jan. 7, 2011

(30) Foreign Application Priority Data
Jun. 28, 2010 (JP) 2010-146763

(51) Int. Cl. G09G 5/00

(52) U.S. Cl. 345/211

(57) ABSTRACT

There is provided a display device including: a pair of substrates; a display medium dispersed between the pair of substrates, and including plural kinds of particle groups that move in accordance with an electric field formed between the substrates and have different colors and different absolute values of movement voltages required to move; a voltage applying unit that applies a voltage between the substrates; a first acquisition unit which acquires area information indicating an area corresponding to plural pixels of an image displayed on the display medium; and a control unit that controls the voltage applying unit to apply voltages, which have the same polarity between pixel areas and are equal to or higher than a maximum value among the absolute values of the movement voltages of the kinds of particle groups, to the respective pixel areas when the first acquisition unit acquires the area information.

### CROSS-REFERENCE TO RELATED APPLICATION

This application is based on and claims priority under 35 USC 119 from Japanese Patent Application No. 2010-146763 filed on Jun. 28, 2010.

### BACKGROUND

1. Technical Field

The present invention relates to a display device.

2. Related Art

As a rewritable image display medium, a display medium using colored particles is known.

### SUMMARY

A first aspect of the present invention provides a display device including:

a pair of substrates at least one of which has light transmission;

a display medium which is dispersed between the pair of substrates, and includes plural kinds of particle groups that move in accordance with an electric field formed between the substrates and have different colors and different absolute values of movement voltages required to move;

a voltage applying unit that applies a voltage between the pair of substrates of the display medium;

a first acquisition unit which acquires area information that indicates an area corresponding to plural pixels of an image that is displayed on the display medium as an area in which a displayed color is to be changed on the display medium; and

a control unit that controls the voltage applying unit to apply voltages, which have the same polarity between pixel areas and are equal to or higher than a maximum value among the absolute values of the movement voltages of the plural kinds of particle groups, to the respective pixel areas that correspond to the plural pixels in the area corresponding to the area information in the display medium when the first acquisition unit acquires the area information.

### BRIEF DESCRIPTION OF THE DRAWINGS

Exemplary embodiments of the present invention will be described in detail based on the following figures, wherein:

FIG. 1 is a general constitutional view of a display medium and a display device according to an embodiment of the invention;

FIG. 2 is an enlarged cross-sectional view schematically illustrating a display medium according to an embodiment of the invention;

FIG. 3 is a line diagram schematically illustrating the relationship between an applied voltage and a display density;

FIG. 4 is a block diagram illustrating the configuration of a control unit according to a first embodiment of the invention;

FIGS. 5A to 5C are schematic views illustrating the color change in an area to be changed of a display medium, which is processed by a control unit, according to a first embodiment of the invention;

FIG. 6 is a flowchart illustrating a voltage applying routine according to the first embodiment of the invention;

FIGS. 7(1) to 7(4) are schematic views illustrating the movement of particle groups in a display medium, which is processed by a control unit, according to the first embodiment of the invention;

FIGS. 8(1) to 8(4) are schematic views illustrating the movement of particle groups in a display medium, which is processed by a control unit, according to a first embodiment of the invention;

FIGS. 9(1) and 9(2) are schematic views illustrating an example of the color change in an area to be changed of a display medium, which is processed by a control unit, according to a first embodiment of the invention;

FIGS. 10(1) and 10(2) are schematic views illustrating the color change in an area to be changed of a display medium in a device in the related art;

FIG. 11 is a block diagram illustrating the configuration of a control unit according to a second embodiment of the invention;

FIG. 12 is a flowchart illustrating a voltage applying routine according to the second embodiment of the invention;

FIGS. 13(1) to 13(5) are schematic views illustrating an example of the color change in an area to be changed of a display medium, which is processed by a control unit, according to the first embodiment of the invention; and

FIGS. 14(1) to 14(8) are schematic views illustrating the movement of particle groups in a display medium in the case of using aggregated particles.

### DETAILED DESCRIPTION

Hereinafter, embodiments of the invention will be described with reference to the accompanying drawings. In the following description, the same drawing reference numerals are used for the elements that perform the same operations or functions even in different drawings, and duplicate explanation thereof may be omitted.

### First Embodiment

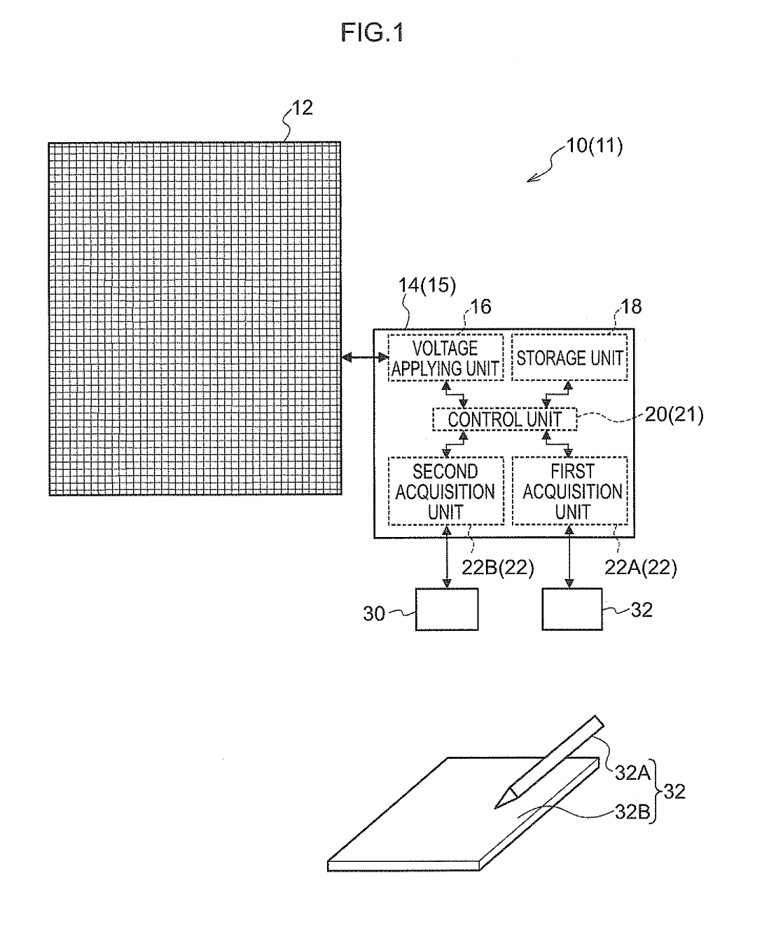

As illustrated in FIG. 1, a display device 10 according to this embodiment includes a display medium 12, and a driving unit 14 that drives the display medium 12.

The driving unit 14 includes a voltage applying unit 16 that applies a voltage to the display medium 12, a storage unit 18, an acquisition unit 22, and a control unit 20. The control unit 20 is electrically connected to the voltage applying unit 16, the storage unit 18, and the acquisition unit 22. The storage unit 18 stores various kinds of data.

The acquisition unit 22 includes a first acquisition unit 22A and a second acquisition unit 22B, and acquires various kinds of data from the outside. The first acquisition unit 22A is connected in a signal exchangeable manner to an indication member 32 that indicates an area in which a displayed color is to be changed on the display medium 12. This indication member 32 is a member for indicating the area in which the displayed color is to be changed on the display medium 12. It is sufficient if the indication member 32 is a member that can output area information that indicates the area in which the displayed color is to be changed on the display medium 12 to the driving unit 14, and the indication member 32 is not limited to a member having a specified configuration.

In this case, the “area to be changed” is an area in which a displayed color is to be changed on a display medium 12, and represents an area that corresponds to plural pixels of an image that is displayed on the display medium 12. That is, the area in which the displayed color is to be changed is not an area that corresponds to one pixel on the display medium 12, but is an area that corresponds to plural pixels.

Also, it is sufficient if the “area information” is information that indicates the area in which the displayed color is to be changed on the display medium 12, and specifically, the area information may be information that indicates position coordinates of the indication member 32.

The indication member 32 may be composed of, for example, a pen-type or mouse-type input device (for example, a stylus pen) 32A for indicating a position or an area on the display medium 12, and a plate member (for example, tablet) 32B for detecting the position (coordinates). The input device 32A is used to add a postscript to an image displayed on the display medium 12 or to designate the area in which the displayed color of the image is to be changed on the display medium 12. The input device 32A may be, for example, a configuration having an infrared output device that outputs infrared rays and an output unit that outputs ultrasonic waves, but is not limited thereto. Also, the plate member 32B may be a construction that is provided with a sensor for sensing the infrared rays output from the input device 32A or a sensor for sensing the ultrasonic waves in sequence to detect the position of the input device 32A. Based on signals output from these sensors, the position of the input device 32A on the plate member 32B is detected, and information that indicates a moving trace of the input device 32A on the surface of the plate member 32B or information that indicates the area pointed to on the plate member 32B is output to the driving unit as the area information that indicates the area in which the displayed color is to be changed.

In the case of using the input device 32A and the plate member 32B as the indication member 32 as described above, a transparent plate member 32B (having light transmissivity of equal to or higher than 80%) may be prepared as the plate member 32B, and may be integrally mounted on the surface of the display medium 12. In the case where the plate member 32B is mounted on the surface of the display medium 12 and the plate member 32B and the display medium 12 are integrally constructed, the area in which the displayed color is to be changed is directly indicated on the display medium 12 by the input device 32A through movement of the input device 32A on the display surface side (the side of a display substrate 34) of the display medium 12. In this case, the plate member 32B may be constructed separately from the display medium 12.

The second acquisition unit 22B is electrically connected to an external device 30 by wire or wirelessly, and acquires from the external device 30 color information that indicates a color (hereinafter may be referred to as a “target color”) which is displayed on the area to be changed that is indicated by the indication member 32 or target color display indication information which indicates that the target color is to be displayed on the area to be changed to which a voltage is applied, that is equal to or higher than the maximum value (hereinafter may be referred to as the “maximum voltage value” to be described in detail later) among absolute values of movement voltages of plural kinds of particle groups 50.

In this embodiment, although the first acquisition unit 22A and the second acquisition unit 22B are separately installed, they may be integrally constructed.

The external device 30 may be an information processing device such as a personal computer or a memory device such as a memory card or the like.

In this case, the display device 10 corresponds to the display device according to an embodiment of the invention. Also, the voltage applying unit 16 corresponds to the voltage applying unit in the display device according to an embodiment of the invention, the storage unit 18 corresponds to the storage unit in the display device according to an embodiment of the invention, the first acquisition unit 22A corresponds to the first acquisition unit in the display device according to an embodiment of the invention, and the second acquisition unit 22B corresponds to the second acquisition unit in the display device according to an embodiment of the present invention. Also, the indication member 32 corresponds to the indication member in the display device according to an embodiment of the invention.

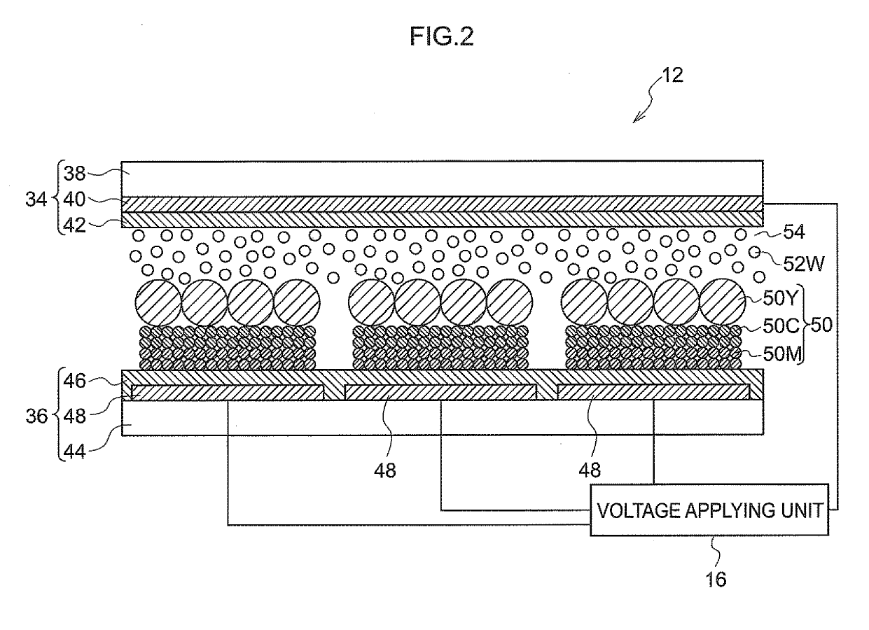

As illustrated in FIG. 2, the display medium 12 includes a display substrate 34 having light transmission (visible light transmissivity of equal to or higher than 70%) as an image display surface, and a rear substrate 36 arranged to face the display substrate 34 at a predetermined interval.

A dispersion medium 54 is filled between the display substrate 34 and the rear substrate 36, and in the dispersion medium 54, white particles 52W and particle groups 50, which move between the display substrate 34 and the rear substrate 36 in accordance with an electric field formed between the substrates, are dispersed.

In this case, the display medium 12 corresponds to the display medium in the display device according to an embodiment of the invention, and the display substrate 34 and the rear surface 36 correspond to a pair of substrates. Also, the particle groups 50 correspond to the plural kinds of particle groups in the display device according to an embodiment of the invention.

The display substrate 34 is constructed so that a display electrode 40 and an insulating layer 42 are installed in sequence on a support substrate 38. The rear substrate 36 is constructed so that plural pixel electrodes 48 are installed on a support substrate 44 at predetermined intervals along a surface direction of the support substrate 44. On the plural pixel electrode 48, an insulating layer 46 is provided.

In this embodiment, a case where an electrode that applies a voltage to the display medium 12 has a so-called active matrix structure will be described.

In this case, the electrode structure on the display medium 12 is not limited to the active matrix structure, but may be a so-called passive matrix structure. Also, the electrodes (the display electrode 40 and the pixel electrodes 48) that apply voltages to the display medium 12 may be formed on the surfaces of the display substrate 34 and the rear substrate 36, which face each other, or may be formed on opposite surfaces to the facing surfaces of the display substrate 34 and the rear surface substrate 36 (outer surfaces). Also, the display electrode 40 and the pixel electrodes 48 for applying voltages to the display medium 12 may be installed on the outside of the substrates as separate bodies from the display substrate 34 and the rear substrate 36.

As the electrode having an active matrix structure, in this embodiment, the display electrode 40, as illustrated in FIG. 2, is installed in the form of a layer to cover the surface on the opposite side to the rear substrate 36 in the support substrate 38 in the surface direction of the support substrate 18. This display electrode 40 is electrically connected to the voltage applying unit 16. In this embodiment, the display electrode 40 is connected to ground (0V), but is not limited thereto.

On the other hand, the pixel electrodes 48 are arranged in plural forms toward both the row and column directions at predetermined intervals along the surface direction of the rear substrate 36 (support substrate 44). The respective pixel electrodes 48 are electrically connected to the voltage applying unit 16, and a voltage is independently applied from the voltage applying unit 16 thereto.

In this embodiment, it is explained that the pixel electrodes 48 are installed in a one-to-one correspondence to the areas that correspond to the respective pixels of an image that is displayed on the display medium 12.

The insulating layer 42 and the insulating layer 46 are layers having an insulation property (having the volume resistivity of equal to or higher than 10¹¹ Ωcm, the same shall apply hereinafter). The insulating layer 42 is installed in the form of a layer on the display electrode 40 that is installed on the support substrate 38. The insulating layer 46 is installed in the form of a layer from the plural pixel electrodes 48 to the side of the display substrate 34 to cover the plural pixel electrodes 48 that are installed on the rear substrate 36.

The dispersion medium 54 is made of insulating liquid, and disperses respective particles constituting the particle group 50 and white particles 52W. In this embodiment, it is explained that the dispersion medium 54 is filled between the display substrate 34 and the rear substrate 36 of the display medium 12. However, the display medium 12 is not limited to the construction filled with liquid, and air may be filled instead of the dispersion medium 54.

The white particles 52W dispersed in the dispersion medium 54 are white particles which do not move even if an electric field is formed between the substrates. In this embodiment, it is explained that the white particles 52W are white. However, it is sufficient if the white particles 52W have a color that is different from the color of the electrophoretic particle groups 50, and is not limited to a white color. Since the non-electrophoretic white particles 52W are dispersed in the dispersion medium 54, for example, the display medium 12 is in a state where the white color display has been performed by the white particles 52W in the case where the whole electrophoretic particles (particle groups 50) are positioned on the side of the rear substrate 36.

The particle groups 50 are electrophoretic particles which move in accordance with the electric field formed between the display substrate 34 and the rear substrate 36 (hereinafter may be simply referred to as “between substrates”).

In this embodiment, it is explained that as the particle groups 50 having different colors, the yellow particle group 50Y, magenta particle group 50M, and cyan particle group 50C are dispersed. However, the particle groups are not limited to three kinds. Also, the colors of the particle groups 50 are not limited to yellow, magenta, and cyan.

The plural kinds of particle groups 50 have different absolute values of the movement voltages that are necessary to move according to the electric field. That is, the respective color particle groups 50 (the particle group 50Y, the particle group 50M, and the particle group 50C) have voltage ranges that are necessary to move the respective color particle groups 50, and the corresponding voltage ranges are different from one another.

Here, the “range of movement voltage” means the voltage range from the voltage when the respective color particle groups 50 start movement toward the other side substrate on the opposite side to the voltage when the movement to the other side substrate on the opposite side is ended in the case where the voltage value of the voltage that is applied between the display substrate 34 and the rear substrate 36 is successively changed in a state where the respective particles that constitute the respective color particle groups 50 (the particle group 50Y, the particle group 50M, and the particle group 50C) are positioned on the side of the display substrate 34 or the rear substrate 36. That is, these plural kinds of particle groups 50 move selectively when the voltage within the range of the movement voltage for each kind of particle groups is applied between the substrates.

In this case, the voltage value when the respective color particle groups 50 start movement to the opposite substrate side is the voltage value of the voltage that is applied between the substrates when the display density of the display medium 12 is changed from a state where the change of the display density does not appear to a state where the change of the display density appears by the movement of the particles that constitute the respective kinds of particle groups 50 in the case where the voltage value of the voltage that is applied between the display substrate 34 and the rear substrate 36 is successively changed.

The state where “the change of the display density appears” means a boundary state when the change of the density on the surface side of the display substrate 34 against the density before the voltage is applied is initially made from the state of less than 0.1 to the state of equal to or higher than 0.1, which is measured by a densitometer (product of X-Rite, Incorporated: X-RITE 404A, trade name) in the case where the voltage is applied to the display electrode 40 and the pixel electrode 48 of the display medium 12 and the voltage value of this voltage is increased or decreased from 0V.

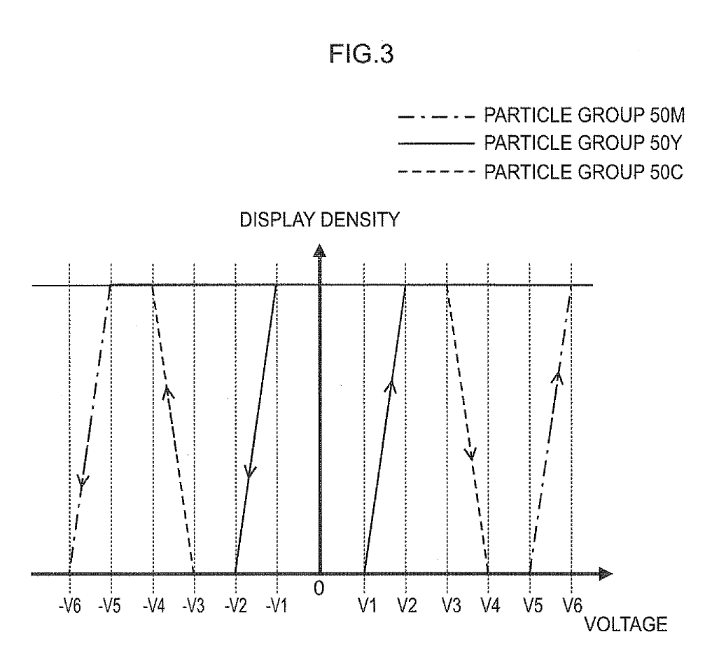

For example, the range of the movement voltage that is necessary to move the particle group 50Y, the particle group 50M, and the particle group 50C, which constitute the plural kinds of particle groups 50, to the side of the display substrate 34 or the side of the rear substrate 36 has the relationship as illustrated in FIG. 3. FIG. 3 shows the result of measuring the density by a densitometer on the side of the display substrate 34 for respective applied voltage values, which are obtained by gradually changing (increasing or decreasing) the voltage that is applied to the pixel electrodes 48 installed on the side of the rear substrate 36 in a state where the display electrode 40 installed on the side of the display substrate 34 is grounded (ground (0V)). Also, the relationship between the applied voltage and the display density in FIG. 3 was measured in a state where only one kind of the white particles 52W and the plural kinds of particle groups 50 is filled in the display medium 12. Also, in FIG. 3, V1, V2, V3, V4, V5, and V6 are different voltage values, and their absolute values are under the relationships of |V1|<|V2|<|V3|<|V4|<|V5|<|V6|.

The movement voltages in the plural kinds of particle groups 50 having different colors and different absolute values of the movement voltages that are required to move are determined by the flow resistances of the surfaces of the respective particles that constitute the particle groups 50 against the dispersion medium 54, an average charge amount, a diameter, and a coefficient of form of each particle. The flow resistance, the average charge amount, the diameter, and the coefficient of form of the particle are adjusted by controlling the material that is composed of the particle groups 50, for example, by controlling the amount of charge control agent or magnetic composition, the kind or density of resin that forms the particles, or by controlling the production conditions of the particles.

In this case, the plural kinds of particle groups 50 have different absolute values of movement voltages necessary to move, but their charged (minus charged or plus charged) polarities may be equal to or different from one another.

In this embodiment, the display medium 12 as constructed above may be used for a rewritable billboard for image preservation, a circular notice, an electronic blackboard, an advertisement, a signboard, a blinking indicator, an electronic paper, an electronic newspaper, an electronic book, and a document sheet commonly used in a copy machine or the like.

In this embodiment, although it is explained that the display medium 12 is in the form illustrated in FIG. 2, it is sufficient if the display medium 12 has a construction in which plural kinds of particle groups 50 are dispersed in the dispersion medium 54 sealed between the display substrate 34 and the rear substrate 36, and is not limited to the form illustrated in FIG. 2.

For example, the rear substrate 36 may have a construction in which TFT (Thin Film Transistors) are provided for the plural pixel electrodes 48. Also, instead of the white particles 52W dispersed in the dispersion medium 54, a reflection member having the optical reflection characteristic different from that of the particle groups 50 may be installed between the substrates. In this case, the term “having the optical reflection characteristic different from that of the particle groups 50” means that there is a distinctive difference in hue, brightness, and saturation between the dispersion medium 54 in which only the particle groups 50 are dispersed and the reflection member in the case where the reflection member is observed by human eyes.

It is sufficient if this reflection member is a member having the above-described characteristic, for example, may be a porus member having holes through which the particle groups 50 pass, a non-woven fabric, or the like.

Also, it is sufficient if the particle groups 50 include particle groups having different colors and different absolute values of movement voltages necessary to move, and may further include particle groups which have different colors and charged polarities, but have the same movement voltage.

In the display medium 12 in this embodiment, as described above, the plural kinds of particle groups 50 have different colors and absolute values of movement voltages necessary to mode. Because of this, a voltage having a voltage value and a polarity according to the color of an object to be displayed is applied between the display electrode 40 and the respective pixel electrodes 48, and the particle groups 50 the kinds of which are according to the applied voltages move between the substrates, so that a color by the subtractive color mixture of the colors of the particle groups 50 is displayed.

Here, the plural kinds of particle groups 50 move between the substrate when the voltage, which has a voltage value that is equal to or larger than the absolute values of the movement voltages of the respective kinds of particle groups and a polarity which makes the plural kinds of particle groups 50 move from the substrate side (either side of the display substrate 34 and the rear substrate 36) on which the particle groups 50 are positioned to the other substrate side, is applied between the substrates.

For example, among the particle group 50Y, the particle group 50M, and the particle group 50C, which constitute the particle groups 50, it is assumed that the particle group 50M is negatively charged with an absolute value |M| of the movement voltage of 15V, the particle group 50C is positively charged with an absolute value |C| of the movement voltage of 10V, and the particle group 50Y is negatively charged with an absolute value |Y| of the movement voltage of 5V. That is, if the relationships of the absolute values of the movement voltages of the plural kinds of the particle groups 50 are |M|>|C|>|Y| and a voltage, which has the voltage value that is equal to or larger than the absolute value |Y| of the movement voltage of the particle group 50Y and is smaller than the absolute value |C| of the movement voltage of the particle group 50C and which has the polarity that moves the negatively charged particle groups 50 to the opposite substrate side in the case of applying to the pixel electrode 48, only the particle group 50Y among the particle group 50C, the particle group 50M, and the particle group 50Y moves between the substrates. However, if a voltage that is equal to or larger than the absolute value of the maximum movement voltage of the particle groups 50 is applied, two or more kinds of particle groups 50, rather than only one kind of particle groups 50, may move between the electrodes in accordance with the positions of the plural kinds of particle groups 50.

Specifically, for example, if a voltage, which has a voltage value that is equal to or larger than the absolute value |Y| of the movement voltage of the particle group 50Y and is smaller than the absolute value |C| of the movement voltage of the particle group 50C and which has the positive polarity that moves the particle group 50Y from the side of the display substrate 34 to the side of the rear substrate 36, is applied to the pixel electrodes 48 in a state where the particle group 50Y, the particle group 50M, and the particle group 50C are positioned on the side of the display substrate 34, only the particle group 50Y moves from the side of the display substrate 34 to the side of the rear substrate 36.

However, if a voltage, which has a voltage value that is equal to or larger than the absolute value |M| of the movement voltage of the particle group 50M and which has the positive polarity that moves the particle group 50M and the particle group 50Y from the side of the display substrate 34 to the side of the rear substrate 36, is applied to the pixel electrodes 48 in a state where the particle group 50Y, the particle group 50M, and the particle group 50C are positioned on the side of the display substrate 34 on the whole, the particle group 50Y and the particle group 50M move from the side of the display substrate 34 to the side of the rear substrate 36.

Because of this, in the case of moving the plural kinds of particle groups 50 so that a display of another target color is performed in a state where one or plural kinds of particle groups 50 are positioned on the side of the display substrate 34 of the display medium 12 to display a specified color, one application of the voltage having the specified voltage value and polarity is rarely performed, but it is necessary to apply plural times the voltage, which has a changed voltage value and polarity in accordance with the voltage values and the charged polarities of the movement voltages of the respective kinds of particle groups 50, between the substrates.

Because of this, for example, in the case of changing the displayed color that is displayed on the display surface of the display medium 12 (in this embodiment, the surface on the side of the display substrate 34) to a desired color, it is necessary to reciprocate the plural kinds of particle groups 50 between the substrates even several times until the target color is displayed, and thus it may take time until the state of the changed color on the area to be changed in the display medium 12 is visually recognized. Particularly, in the case of adding a postscript onto an image that is displayed on the display medium 12 using the indication member 32, it may take time until the trace of movement of the indication member 32 is reflected in the display medium 12.

Accordingly, in this embodiment, when the first acquisition unit 22A acquires area information that indicates areas that correspond to plural pixels of an image that is displayed on the display medium 12 as the area to be changed of the displayed color on the display medium 12, the control unit 20 of the display device 10 controls the voltage applying unit 16 to apply a voltage, which has a voltage value (maximum voltage value) that is equal to or larger than the maximum value among absolute values of the movement voltages of plural kinds of particle groups 50 having different colors and absolute values of the movement voltages and which has the same polarity between the pixel areas, to the respective areas that correspond to the plural pixels in an area that corresponds to the area information in the display medium 12.

Because of this, in the display medium 12, the color on the area to be changed is changed at high speed in comparison to the case where the present construction is not adopted.

The control unit 20 of the display device 10 performs the above-described control operation.

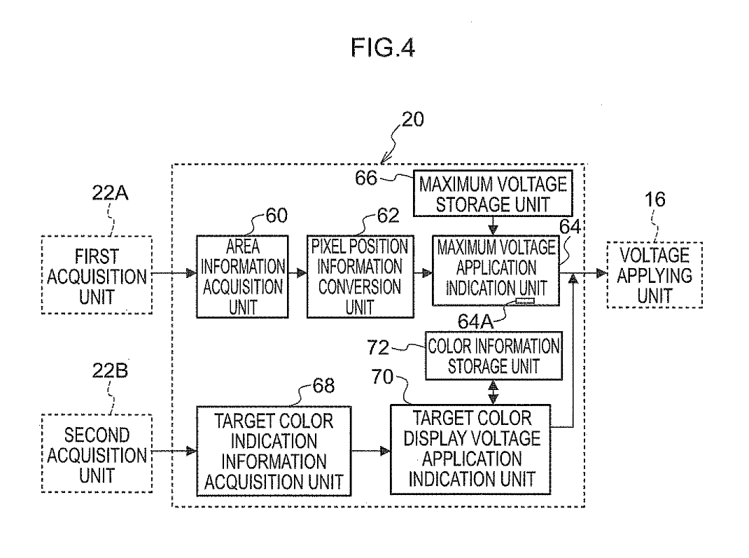

The control unit 20 includes a CPU (Central Processing Unit), a ROM (Read Only Memory) that stores a voltage applying program for realizing a voltage applying routine to be described later, a RAM (Random Access Memory) that stores data or the like, and a bus that connects the above-described elements. In explaining the control unit 20 with function blocks which are divided for each function realizing means that is determined based on hardware and software, as illustrated in FIG. 4, the control unit 20 includes an area information acquisition unit 60, a pixel position information conversion unit 62, a maximum voltage storage unit 66, a maximum voltage application indication unit 64, a target color display indication information acquisition unit 68, a color display voltage application indication unit 70, and a color information storage unit 72.

The area information acquisition unit 60 acquires area information that indicates the area to be changed of the displayed color on the display medium 12, which is indicated by the indication member 32, through the first acquisition unit 22A. The pixel position information conversion unit 62 converts the area information that is received by the area information acquisition unit 60 into information that indicates the position of the respective pixel electrodes 48 on the display medium 12. Accordingly, the information that indicates the area to be changed of the displayed color on the display medium 12 is converted into the information that indicates the plural pixel electrodes 48 arranged in positions that correspond to the area to be changed. Also, the pixel position information conversion unit 62 pre-stores information that indicates pixel areas that correspond to the respective pixels on the display medium 12 to correspond to the area information (position coordinates) that is indicated by the indication member 32, and information (position information) that indicates the pixel electrodes 48 arranged in the respective pixel areas. Also, the pixel position information conversion unit 62 reads the information that indicates the positions of the plural pixel electrodes 48, which corresponds to the area information that is received by the area information acquisition unit 60, and converts the area information received by the area information acquisition unit 60 into the information that indicates the positions of the respective pixel electrodes 48 on the display medium 12.

The maximum voltage storage unit 66 stores maximum voltage value information that indicates a voltage value (maximum voltage value) that is equal to or larger than the maximum value among absolute values of movement voltages of the plural kinds of particle groups 50 which are sealed in the display medium 12.

It is sufficient if this “maximum voltage value” is the information that indicates the voltage value that is equal to or larger than the maximum value among the absolute values of the movement voltages of the plural kinds of particle groups 50 sealed in the display medium 12, and for example, the voltage value is determined in a range which is equal to or larger than the maximum value among the absolute values of the movement voltages of the plural kinds of particle groups 50 sealed in the display medium 12 and which is equal to or smaller than the maximum voltage value that can be applied in the display device 10. In this case, the maximum voltage value information is pre-measured and stored in the maximum voltage storage unit 66.

The maximum voltage application indication unit 64 outputs the maximum voltage application indication information to the voltage applying unit 16. This maximum voltage application indication information is information indicating that the voltage of the maximum voltage value of the maximum voltage value information, which is read from the maximum voltage storage unit 66, is applied to the respective pixel electrodes 48 obtained by the pixel position information conversion unit 62 with a polarity that is read from the storage unit 64A that stores polarity information. Specifically, the maximum voltage application indication information includes maximum voltage value information read from the maximum voltage storage unit 66, polarity information that indicates the polarity read from the storage unit 64A, position information that indicates positions of the respective pixel electrodes 48 obtained by the pixel position information conversion unit 62, and indication information that indicates the voltage application.

The voltage applying unit 16, which has received the maximum voltage application indication information, reads the maximum voltage value information that is included in the maximum voltage application indication information, polarity information, position information that indicates the positions of the pixel electrodes 48, and indication information, and applies the voltage of the read maximum voltage value to the respective pixel electrodes 48 that correspond to the read position information with the read polarity.

In this case, the storage unit 64A in which the polarity information is stored is installed in the maximum voltage application indication unit 64. This polarity information is information that indicates the applied polarity of the voltage of the maximum voltage value, and the storage unit 64A pre-stores the information that indicates a positive polarity or a negative polarity as the polarity information.

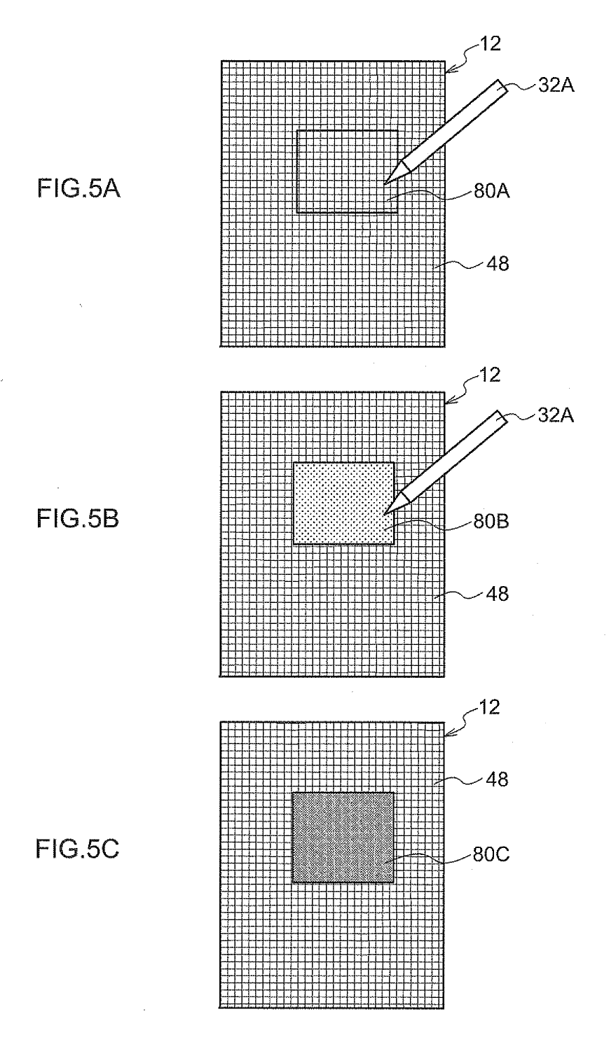

As described above, if the processes are performed by the area information acquisition unit 60, the pixel position information conversion unit 62, and the maximum voltage application indication unit 64, the maximum voltage application indication information is output from the maximum voltage application indication unit 64 to the voltage applying unit 16. For example, as illustrated in FIG. 5A, it is assumed that a specified area 80A, which includes areas that correspond to the plural pixel electrodes (pixels) 48 among the whole area that corresponds to the plural pixel electrodes 48 installed in the display medium 12, is indicated by an input device 32A as the area to be changed of the displayed color. In this case, the maximum voltage application indication information is output from the maximum voltage application indication unit 64 to the voltage applying unit 16, and thus the voltage of the maximum voltage value is applied from the voltage applying unit 16 to the plural pixel electrodes 48 that exist in the area 80A with the same polarity (positive or negative polarity) as that between the respective pixel electrodes 48. Accordingly, the area 80B on the display medium 12, to which the voltage of the maximum voltage value is applied, is in a state where a color that is different from the color before the voltage is applied is displayed through the application of the voltage of the maximum voltage value (see FIG. 5B).

On the other hand, the target color display indication information acquisition unit 68 acquires target color display indication information for indicating that the target color is displayed on the area to be changed. This target color display indication information is indicated by an external device 30, and is input to the target color display indication information acquisition unit 68 through the second acquisition unit 22B.

At this time, the target color indicates a target color to be displayed on the area to be changed that is indicated by the indication member 32. Color information that indicates the target color includes information that indicates colors displayed for respective pixel areas that correspond to the respective pixel electrodes 48. Specifically, the color information that indicates the target color includes position information that indicates the positions of the respective pixel electrodes 48 and information that indicates desired colors displayed for the respective pixel electrodes 48. The color information is pre-indicated by the external device 30, and is stored in the color information storage unit 72 through the second acquisition unit 22B.

If the target color display indication information acquisition unit 68 acquires the target color display indication information, the color display voltage application indication unit 70 first reads information, which indicates the target color that is displayed for the respective pixel electrodes 48 corresponding to the position information that indicates the positions of the pixel electrodes 48 in the area to be changed, from the color information storage unit 72.

Then, the color display voltage application indication unit 70 outputs the target color display voltage application indication information to the voltage applying unit 16 based on the read information. The target color display voltage application indication information is information indicating that the voltage for displaying the target color is applied to the respective pixel electrodes 48 in the area to be changed to which the voltage of the maximum voltage value is applied. Specifically, the color display voltage application indication information includes position information that indicates the positions of the pixel electrodes 48 that apply the voltage, voltage application information for displaying the target color, and indication information that indicates the voltage application.

In this case, the voltage application information for displaying the target color is information that indicates a voltage application procedure that is necessary to display the target color, and includes a voltage value of the voltage to be applied, the polarity of the voltage, and one or plural pulse signals that indicate a voltage application time. That is, the voltage application information for displaying the target color that exists in areas that correspond to the respective pixel electrodes 48 in the area to be changed in the display medium 12 is information that indicates a voltage that moves one or plural kinds of particle groups 50 between the substrates once or plural times.

If the target color display voltage application indication information is output to the voltage applying unit 16, the voltage applying unit 16 reads the information that indicates the pixel electrodes 48 that apply the voltage, the voltage application information that indicates the target color, and the indication information, which are included in the target color display voltage application indication information, and applies the voltage according to the read voltage application information to the respective pixel electrodes 48 that correspond to the read position information.

For example, if the target color display voltage application indication information is output to the voltage applying unit 16, the voltage for displaying the target color is applied to the respective pixel electrodes 48 in the area 80B (see FIG. 5B) to which the voltage of the maximum voltage value is applied, and the target color is displayed on the respective pixel areas in the area to be changed (see FIG. 5C). In FIG. 5C, the same target color is displayed on the respective pixel areas (areas corresponding to the pixel electrodes 48). However, the display of the target color is not limited thereto, and target colors indicated according to the respective pixel electrodes 48 may be displayed on the respective pixel areas.

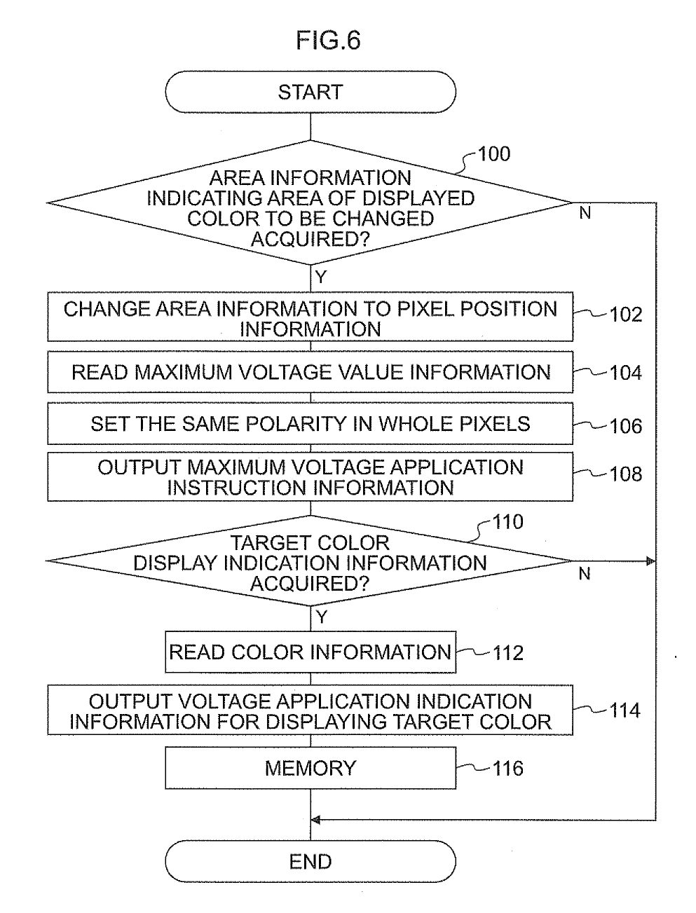

Next, a voltage applying routine that is performed by the control unit 20 will be described with reference to FIG. 6.

In this case, it is assumed that a magenta particle group 50M, a cyan particle group 50C, and a yellow particle group 50Y are sealed in the display medium 12 as the particle groups 50. Also, among the particle group 50Y, the particle group 50M, and the particle group 50C, which constitute the particle groups 50, it is assumed that the particle group 50M is negatively charged with an absolute value |M| of the movement voltage of 15V, the particle group 50C is positively charged with an absolute value |C| of the movement voltage of 10V, and the particle group 50Y is negatively charged with an absolute value |Y| of the movement voltage of 5V. That is, a case where the relationships of the absolute values of the movement voltages of the plural kinds of the particle groups 50 are |M|>|C|>|Y| will be described as an example.

In step 100, it is determined whether the area information that indicates the area to be changed of the displayed color on the display medium 12 is acquired, and if no, the routine is ended, while if yes, step 102 is performed. The determination in step 100 is performed by determining whether the area information is acquired by the first acquisition unit 22A.

Next, in step 102, the area information acquired in step 100 is converted into the information that indicates the positions of the respective pixel electrodes 48 on the display medium 12. In step 104, the maximum voltage value (the voltage value that is equal to or larger than the maximum value among the absolute values of the movement voltages of the plural kinds of particle groups 50 which are sealed in the display medium 12) information is read from the maximum voltage storage unit 66. In step 106, the polarity information, which indicates the polarity of the voltage to be applied, is read from the storage unit 64 in which the polarity information is stored, and a voltage having the same polarity is set as the voltage that is applied to the whole of the plural pixel electrodes 48 included in the area information that is acquired in step 100.

Next, in step 108, the maximum voltage application indication information is generated based on the information which indicates the positions of the respective pixel electrodes 48 on the display medium 12 and corresponds to the area to be changed, obtained by the process in step 102, the maximum voltage value information read in step 104, and the polarity information set in step 106, and the generated maximum voltage application indication information is output to the voltage applying unit 16.

By performing the processes in steps 100 to 108, the voltage of the maximum voltage value is applied to the plural pixel electrodes 48 arranged inside the area to be changed with the same polarity between the respective pixel electrodes 48. Accordingly, in the display medium 12, the plural kinds of particle groups 50 that exist in the area that is indicated as the area to be changed move in a direction according to the applied polarity on the side of the rear substrate 36 or the side of the display substrate 34.

In step 110, it is determined whether the target color display indication information is acquired, and if no, the routine is ended, while if yes, step 112 is performed. The determination in step 110 is performed by determining whether the target color display indication information is input to the target color display indication information acquisition unit 68 through the second acquisition unit 22B.

Next, in step 112, information, which indicates the target color that is displayed on the plural pixel areas on the display medium 12, which corresponds to the area to be changed of the area information acquired in step 100, is read from the color information storage unit 72. In step 114, the target color display voltage application indication information is output to the voltage applying unit 16 based on the information read in step 112.

Next, in step 116, the information that indicates the target color corresponding to the respective pixel electrodes 48 that is indicated by the voltage application information for displaying the target color corresponding to the information that indicates the respective pixel electrodes 48, which is included in the target color display voltage application indication information output to the voltage applying unit 16 in step 114, and the position information that indicates the positions of the pixel electrodes 48 that indicates the target color are correspondingly stored in the storage unit 18, and then the routine is ended. Accordingly, the information which indicates the color that is currently displayed on the respective pixel areas on the display medium 12 is stored in the storage unit 18.

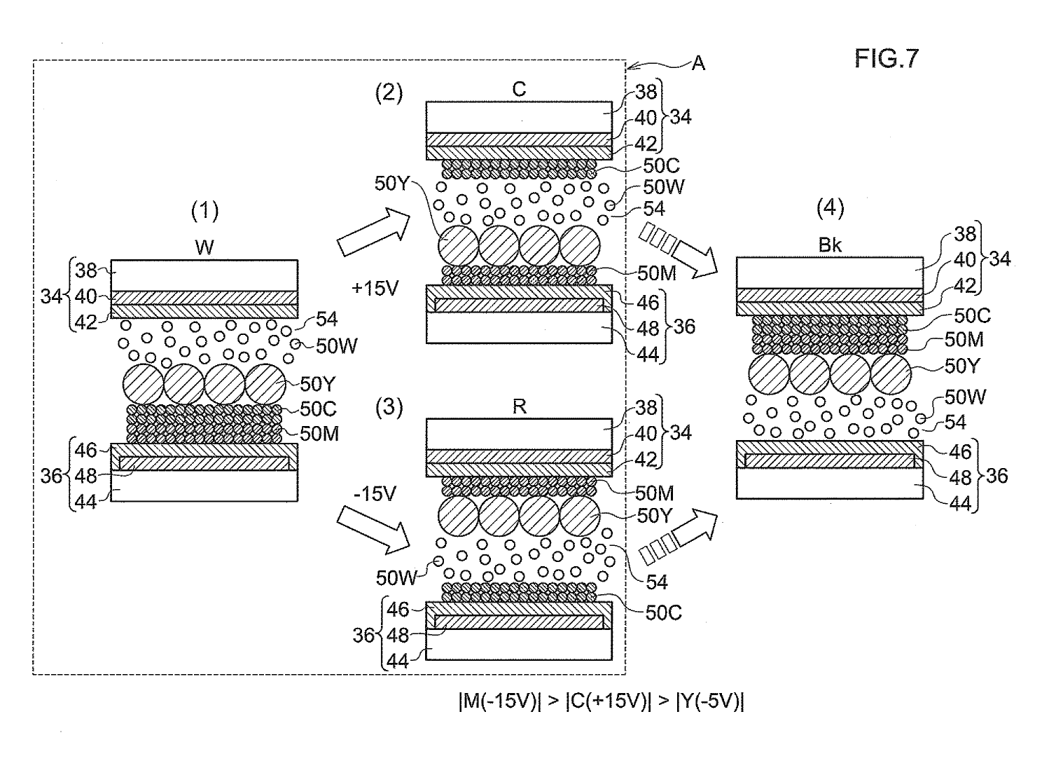

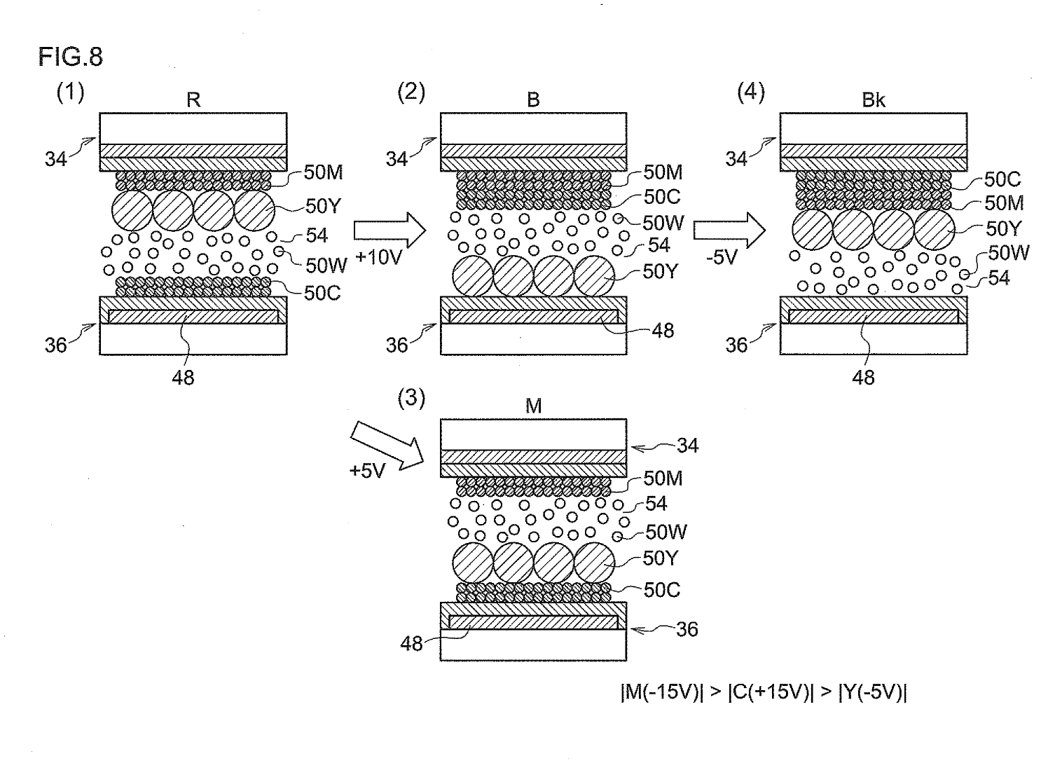

By performing the processes in steps 100 to 116, for example, movement (electrophoresis) of the particle groups 50 as shown in FIGS. 7 and 8 occurs in the display medium 12.

In this case, in FIGS. 7 and 8, for simplified explanation, the movement of the particle groups 50 is illustrated focusing on a pixel area that corresponds to one pixel electrode 48. However, it is preferable that the area to be changed is an area that includes plural pixels.

As illustrated in FIG. 7(1), it is assumed that the white color is displayed on the area that corresponds to a specified electrode 48 in the area to be changed of the displayed color. Also, it is assumed that the black color is indicated as the target color to be displayed in the area to be changed.

In this case, if the processes in steps 100 to 108 are performed, the voltage of the maximum voltage value is applied to the pixel electrode 48 with a specified polarity. Accordingly, a voltage of 15V that is the maximum value among the absolute values of the movement voltages of the particle groups 50 is applied to the pixel electrodes 48, in the area in which the white color has been displayed as the whole particle groups 50 are arranged on the side of the rear substrate 36. Accordingly, the particle groups 50 moves in the area A in FIG. 7.

Specifically, if the positive polarity is set as the polarity of the applied voltage in the process in step 106, a voltage of +15V is applied to the pixel electrodes 48. As described above, if the voltage of +15V is applied to the pixel electrodes 48 in the display medium 12 on which the white color display (W display) has been performed as shown in FIG. 7(1), the particle group 50C among the particle group 50Y, the particle group 50M, and the particle group 50C, which are arranged on the side of the rear substrate 36, moves to the side of the display substrate 34. Accordingly, on the side of the display substrate 34, cyan color by the particle group 50C is displayed (C display) (see FIG. 7(2)).

On the other hand, if the negative polarity is set as the polarity of the applied voltage in the process in step 106, a voltage of −15V is applied to the pixel electrodes 48. As described above, if the voltage of −15V is applied to the pixel electrodes 48 in the display medium 12 on which the white color display (W display) has been performed as shown in FIG. 7(1), the particle group 50M and the particle group 50Y among the particle group 50Y, the particle group 50M, and the particle group 50C, which are arranged on the side of the rear substrate 36, move to the side of the display substrate 34. Accordingly, on the side of the display substrate 34, red color by the particle group 50M and the particle group 50Y is displayed (R display) (see FIG. 7(3)).

As described above, in the display device 10 according to this embodiment, when the area information that indicates the area to be changed (the area that corresponds to the plural pixels of an image that is displayed on the display medium 12) is acquired, the voltage that is equal to or larger than the maximum value (maximum voltage value) among the absolute values of the movement voltages of the plural kinds of particle groups 50 is applied with the same polarity between the respective pixel electrodes 48. Accordingly, it is considered that the color on the area to be changed on the display medium 12 is changed at high speed in comparison to the case in the related art.

Also, since the voltage of the maximum voltage value has the same polarity between the plural pixel electrodes 48 in the area to be changed, it is considered that the color on the area to be changed on the display medium 12 is changed at higher speed in comparison to the case in the related art.

Also, in the case where the target color display indication information that indicates the display of the target color on the area to be changed is acquired after the voltage of the maximum voltage value is applied to the respective pixel electrodes 48 in the area to be changed, the processes in steps 110 to 116 are performed, and for example, the movement of the particle groups 50 as described below occurs.

Specifically, in the display medium 12 in a state where the cyan color is displayed (C display) as shown in FIG. 7(2) through the application of the voltage of the maximum voltage value as a voltage for displaying a black color that is a target color, a voltage, which has a voltage value and a polarity for moving at least one kind of particle groups 50 to the side of the display substrate 34 or the rear substrate 36 once or plural times, is applied to the pixel electrodes 48. By this, finally, the black color by the particle group 50M, the particle group 50Y, and the particle group 50C is displayed (Bk display) as the target color (see FIG. 7(4)).

Specifically, in order to change the state where the red color is displayed (R display) as shown in FIG. 7(3) to the state where the black color is displayed (Bk display) as shown in FIG. 7(4), for example, if a voltage of +10V is applied to the pixel electrode 48 in the display medium 12 in the state where the red color is displayed (R display) as shown in FIGS. 7(3) and 8(1), the particle group 50C that has been arranged on the side of the rear substrate 36 moves to the side of the display substrate 34, and the particle group 50Y that has been arranged on the side of the display substrate 34 moves to the side of the rear substrate 36. Accordingly, on the side of the display substrate 34, a blue color by the particle group 50C and the particle group 50M is displayed (B display) (see FIG. 8(2)).

Also, if a voltage of −5V is applied to the pixel electrode 48 in the display medium 12 in the state where the blue color is displayed (B display) as shown in FIG. 8(2), the particle group 50Y, which has been arranged on the side of the rear substrate 36, moves to the side of the display substrate 34. Accordingly, on the side of the display substrate 34, the black color by the particle group 50C, the particle group 50M, and the particle group 50Y is displayed (Bk display) (see FIGS. 8(4) and 7(4)).

In the case where the target color is magenta, if a voltage of +5V is applied to the pixel electrodes 48 in the display medium 12 in a state where the red color is displayed (R display) as shown in FIGS. 7(3) and 8(1) through the application of the voltage of the maximum voltage value, the particle group 50C, which has been arranged on the side of the display substrate 34, moves to the side of the rear substrate 36. Accordingly, on the side of the display substrate 34, the magenta color by the particle group 50M is displayed (M display) (see FIG. 8(3)).

Also, for example, by performing the processes in steps 100 to 116, an image as described below is displayed on the display medium 12.

For example, it is assumed that a transparent plate member 32B (see FIG. 1) is mounted on the side of the display substrate 34 of the display medium 12 and a line image is written on the plate member 32B by moving the front end of the input device 32A on the surface of the plate member 32B using the pen type input device 32A. Also, it is assumed that a black color is pre-indicated and stored in the color information storage unit 72 as the color (target color) of the line image.

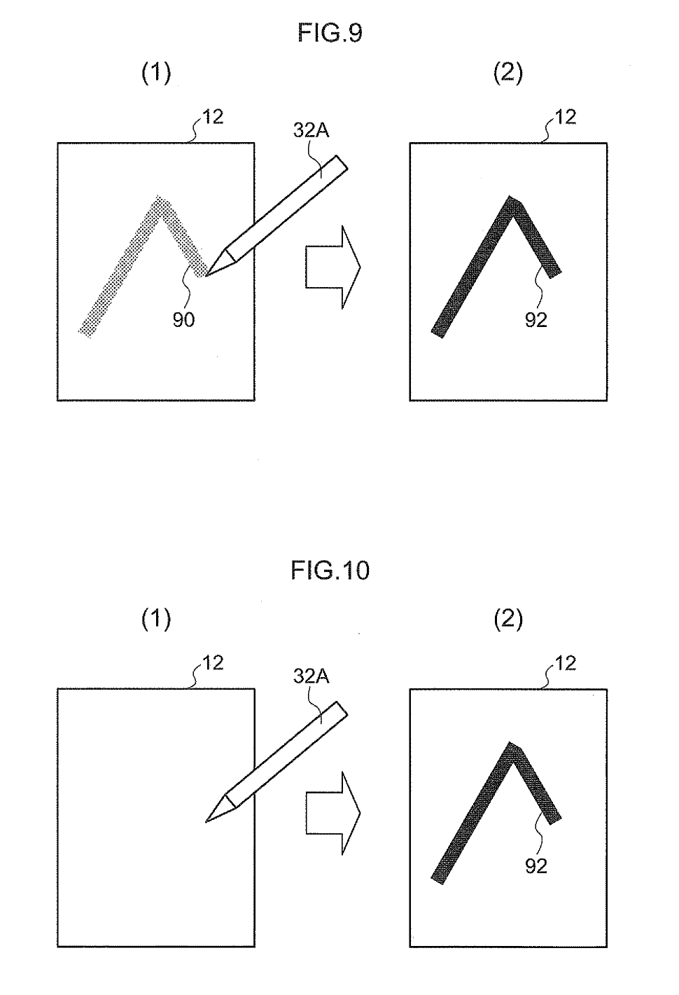

In this case, by performing the processes in steps 100 to 116, the color of the area 90 to be changed (see FIG. 9(1)) according to the trace of the input device 32A is changed at high speed on the side of the display substrate 34 of the display medium 12 in this embodiment. Thereafter, in the case of acquiring the indication information which indicates the target color that is designated as the color to be displayed on the area to be changed, as illustrated in FIG. 9(2), the trace on the area 92 to be changed is displayed on the display medium 12 with the black color that is the target color.

On the other hand, in the case of applying a voltage for displaying the target color on the area to be changed by performing the processed in steps 112 to 116 after performing the process in step 100, without performing the output of the maximum voltage application indication information to the voltage applying unit 16 through the processes in steps 100 to 108, even if the front end of the input device 32A is moved on the surface of the plate member 32B, as illustrated in FIG. 10(1), the trace of the movement is not displayed at high speed as in this embodiment, and the color change (see FIG. 9(1)) by the application of the voltage of the maximum voltage value, in the display device 10 in this embodiment, is delayed, so that the trace on the area 92 to be changed is displayed on the display medium 12 with the black color (see FIG. 10(2)).

In this embodiment, the area to be changed on the display medium 12 is not limited to a partial area that includes the plural pixel areas on the display medium 12, and may be the whole area.

Also, in this embodiment, although it is exemplified that the processes in steps 112 to 116 are performed after the determination in step 110, the processing may proceed from step 108 to step 112 without performing the determination in step 110.

### Second Embodiment

Next, a second embodiment of the invention will be described. Since the configuration of the display device according to the second embodiment of the invention is the same as that according to the first embodiment, the same reference numerals are used for the constituent elements, and the explanation thereof will be omitted.

The second embodiment is different from the first embodiment on the point that the polarity of the voltage of the maximum voltage value being applied is determined for each pixel area (pixel electrode 48) according to the color currently displayed on the respective pixel areas of the area to be changed.

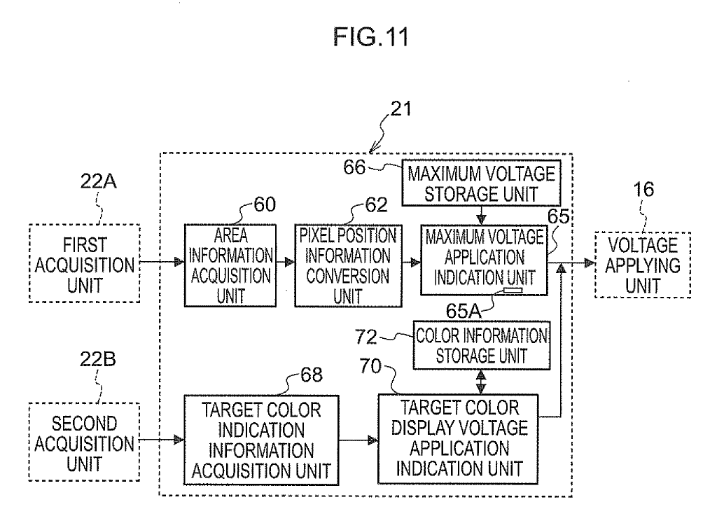

As illustrated in FIGS. 1 and 11, the display device 11 according to the second embodiment of the invention includes a display medium 12, and a driving unit 15 that drives the display medium 12. The driving unit 15 includes a voltage applying unit 16 that applies a voltage to the display medium 12, a storage unit 18, an acquisition unit 22, and a control unit 21. The control unit 21 is electrically connected to the voltage applying unit 16, the storage unit 18, and the acquisition unit 22.

The control unit 21 includes a CPU (Central Processing Unit), a ROM (Read Only Memory) that stores a second voltage applying program for realizing a second voltage applying routine to be described later, a RAM (Random Access Memory) that stores data or the like, and a bus that connects the above-described elements. In explaining the control unit 21 with function blocks which are divided for each function realizing means that is determined based on hardware and software, as illustrated in FIG. 11, the control unit 21 includes an area information acquisition unit 60, a pixel position information conversion unit 62, a maximum voltage storage unit 66, a maximum voltage application indication unit 65, a target color display indication information acquisition unit 68, a color display voltage application indication unit 70, and a color information storage unit 72.

That is, the control unit 21 in the second embodiment is different from the control unit 20 in the first embodiment on the point that the control unit 21 in this embodiment has the maximum voltage application indication unit 65 instead of the maximum voltage application indication unit 64.

Also, in this embodiment, the color information which indicates the target color and is included in the target color display indication information that is acquired by the target color display indication information acquisition unit 68, in the same manner as the first embodiment, includes position information that indicates positions of the respective pixel electrodes 48 and information that indicates the target color that is displayed for the respective pixel electrodes 48, and as the information that indicates the target color, information that indicates different colors between the respective pixel electrodes 48 may be included.

Also, in this embodiment, the area information acquisition unit 60 acquires area information that indicates the area to be changed of the displayed color on the display medium 12, which is indicated by the indication member 32, and the color information is considered to be included in an area that corresponds to another pixel having different color information (pixel electrode 48).

The maximum voltage application indication unit 65 outputs second maximum voltage application indication information to the voltage applying unit 16. This second maximum voltage application indication information is information indicating that the voltage of the maximum voltage value of the maximum voltage value information, which is read from the maximum voltage storage unit 66, is applied to the respective pixel electrodes 48 obtained by the pixel position information conversion unit 62 with a polarity that is determined for each pixel electrode 48. Specifically, the second maximum voltage application indication information includes maximum voltage value information read from the maximum voltage storage unit 66, position information that indicates positions of the respective pixel electrodes 48 obtained by the pixel position information conversion unit 62, information that indicates the polarity of the voltage that is applied to the respective pixel electrodes 48, and indication information that indicates the voltage application.

The polarities of the voltages that are applied to the pixel electrodes 48 are polarities of the voltages of the maximum voltage value that are determined so that a color, which is different from the color that is displayed on the respective pixel areas in the area to be changed, is displayed on the display medium 12. That is, even if a voltage of +15V (which is the voltage of the maximum voltage value and has a positive polarity) is applied to the pixel electrode 48 in a specified pixel area on the display medium 12, the currently displayed color is not changed. However, if a voltage of −15V (which is the voltage of the maximum voltage value and has a negative polarity) is applied, the currently displayed color is changed, and in this case, a negative (minus) polarity is determined as the polarity of the voltage of the maximum voltage value that is applied to the pixel electrode 48.

The polarity for each pixel electrode 48 is pre-stored in the storage unit 65A installed in the maximum voltage application indication unit 65 so that the color information that indicates the color displayed on the display medium 12 and the polarity information, which indicates the polarity of the voltage that makes the displayed color changed when the voltage of the maximum voltage value is applied to the pixel electrode 48 on the area on which the color of the color information is displayed, are correspondingly stored. The color information that corresponds to the information that indicates the positions of the respective pixel electrodes 48 obtained by the pixel position information conversion unit 62 is read from the color information storage unit 72, and the read color information is determined as information that indicates the currently displayed color. Also, the polarity information that corresponds to the read color information that indicates the currently displayed color is read from the storage unit 65A, and is set as the polarity information of the voltage of the maximum voltage value that is applied to the pixel electrodes 48 of the pixel areas on which the color of the color information is displayed.

The voltage applying unit 16, which has received the second maximum voltage application indication information, reads the maximum voltage value information, the polarity information, the position information that indicates the positions of the pixel electrodes 48, and the indication information, which are included in the second maximum voltage application indication information, and applies the read voltage of the maximum voltage value to the respective pixel electrodes 48 that correspond to the read position information with the polarity that corresponds to the respective pixel electrodes 48.

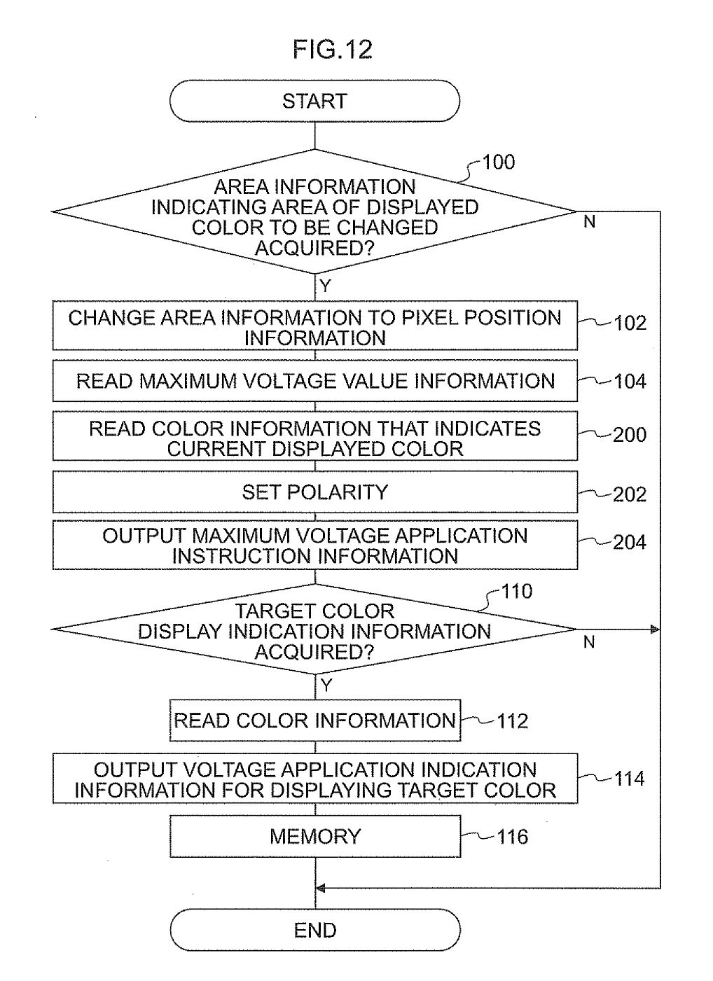

Next, in step 100, a second voltage applying routine that is performed by the control unit 21 will be described with reference to FIG. 12.

In this case, in the same manner as the first embodiment, explanation will be made on the assumption that a magenta particle group 50M, a cyan particle group 50C, and a yellow particle group 50Y are sealed in the display medium 12 as the particle groups 50. Also, among the particle group 50Y, the particle group 50M, and the particle group 50C, which constitute the particle groups 50, it is assumed that the particle group 50M is negatively charged with an absolute value |M| of the movement voltage of 15V, the particle group 50C is positively charged with an absolute value |C| of the movement voltage of 10V, and the particle group 50Y is negatively charged with an absolute value |Y| of the movement voltage of 5V. That is, a case where the relationships of the absolute values of the movement voltages of the plural kinds of the particle groups 50 are |M|>|C|>|Y| will be described as an example.

Also, the same reference numerals are used for the same processes as the voltage applying routine that is performed by the control unit 20 in the first embodiment, and detailed explanation thereof will be omitted.

In step 100, it is determined whether the area information that indicates the area to be changed of the displayed color on the display medium 12 is acquired, and if no, the routine is ended, while if yes, step 102 is performed. Next, in step 102, the area information acquired in step 100 is converted into the information that indicates the positions of the respective pixel electrodes 48 on the display medium 12. In step 104, the maximum voltage value (the voltage value that is equal to or larger than the maximum value among the absolute values of the movement voltages of the plural kinds of particle groups 50 which are sealed in the display medium 12) information is read from the maximum voltage storage unit 66.

Next, in step 200, the color information which corresponds to the information that indicates the positions in the plural pixel electrodes 48 on the display medium 12, which corresponds to the area to be changed of the area information acquired in step 100, obtained by conversion in step 102, is read from the color information storage unit 72 as the information that indicates the color that is currently displayed on the respective pixel regions.

Next, in step 202, the polarity information, which corresponds to the color information that indicates the currently displayed color read in step 200, is read from the storage unit 65A, and the polarity of the voltage of the maximum voltage that is applied to the respective pixel electrode 48 is set.

Next, in step 204, the second maximum voltage application indication information is generated based on the information which indicates the positions of the respective pixel electrodes 48 on the display medium 12 and corresponds to the area to be changed, obtained by the process in step 102, the maximum voltage value information read in step 104, and the polarity information set for each pixel electrode 48 in the area to be changed in step 202, and the generated second maximum voltage application indication information is output to the voltage applying unit 16.

Next, after the processes in steps 110 to 116 are performed as illustrated in FIG. 6, the routine is ended.

By performing the processes in steps 100 to 104 and steps 200 to 204, as illustrated in FIG. 12, the voltage of the maximum voltage value is applied to the pixel electrodes arranged on the position that corresponds to the respective pixel areas on the display medium 12, which corresponds to the area to be changed of the area information acquired in step 100, with the polarity that is determined to display a color, different from the color currently displayed on the pixel area.

Accordingly, in the display device 11 according to the second embodiment of the invention, since the polarity of the voltage of the maximum voltage value is set so that the color that is different from color currently displayed on the area to be changed is displayed when the voltage of the maximum voltage value is applied, the color of the area on which a postscript is added onto an image that has been already displayed on the display medium 12 becomes different from the background color (the color that has been already displayed on the display medium 12).

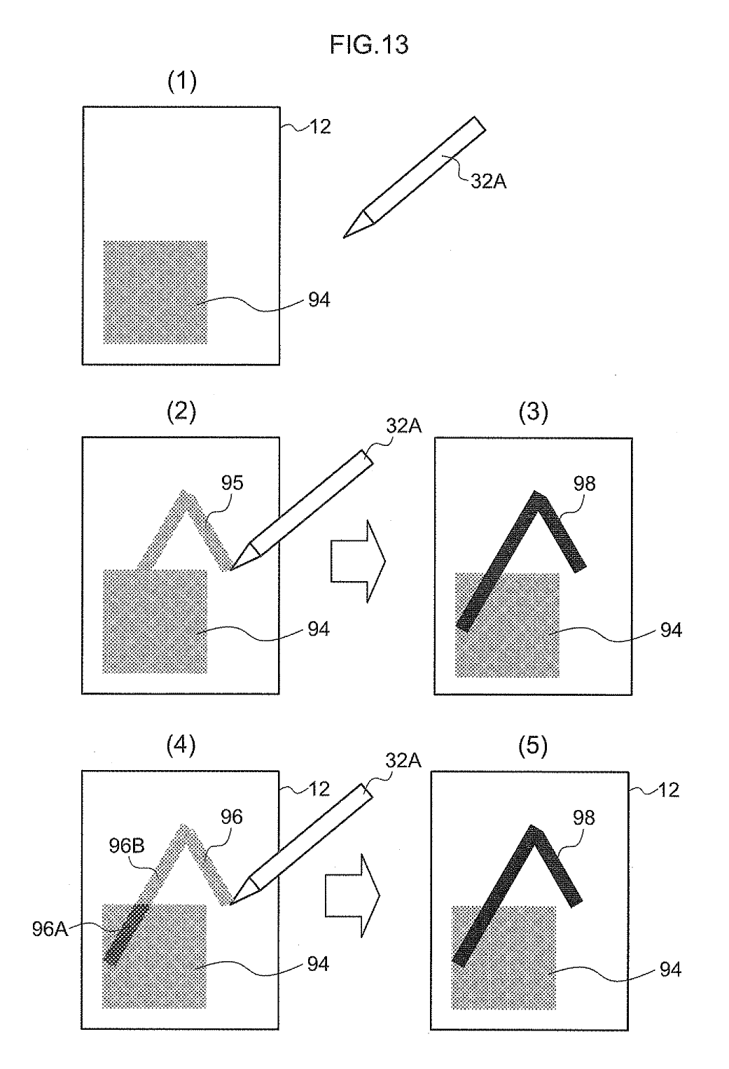

Specifically, as illustrated in FIG. 13(1), in the case where the image 94 is formed on the display medium 12 and another image is added onto the display medium 12, that is, in the case where a new image 95 is added as the area to be changed using the input device 32A, the color of the trace may be changed to the same color as the image 94 already displayed, as illustrated in FIG. 13(2), according to the polarity of the applied voltage of the maximum voltage value, and thus the trace may not be recognized. Also, in the case of acquiring the target color display indication information that indicates the display of the target display, the image 98 is displayed on the image 94 already displayed with a target color (see FIG. 13(3)).

On the other hand, according to the display device 11 in this embodiment, since the polarity of the voltage of the maximum voltage value is controlled according to the color (background color) that is currently displayed on the display medium 12, as illustrated in FIG. 13(4), if a new image 96 is added as the area to be changed using the input device 32A so that the new image 96 partially overlaps the area of the image 94 already displayed on the display device 12, a color that is different from the color of the image 94 that is the background is displayed on the area 96A that overlaps the area of the image 94 in the image 96. Also, in the case of acquiring the target color display indication information that indicates the display of the target color, the image 98 is displayed on the image 94 already displayed with the target color (see FIG. 13(5)).

In the above described embodiments (the first embodiment and the second embodiment), it is explained that plural kinds of particle groups 50 having different colors and absolute values of the movement voltages necessary to move are included as electrophoretic particle groups 50. However, as the electrophoretic particle groups 50, other particle groups which have the same movement voltage but have different charged polarities may be further included.

Also, in this embodiment, the plural kinds of particle groups 50 that are included in the display medium 12 move independently when the voltage which has a different charge polarity and is equal to or higher than the absolute values of the movement voltages is applied between the substrates, and the particle groups 50 form an aggregate which is positively or negatively charged and includes two or more kinds of electrophoretic particle groups when the voltage that is lower than the absolute values of the movement voltages is applied between the substrates.

In this case, the aggregation between two different kinds of particle groups is controlled, for example, by attaching a polymeric dispersant for controlling the aggregation to the surface of the particles that constitute the particle groups. For example, if silicon oil is used as a dispersion medium and a polymeric dispersant having compatibility with the silicon oil is attached to the surfaces of the particles, the polymeric dispersant is spread in the dispersion medium. Accordingly, if both the two kinds of particle groups have the above-described polymeric dispersant on their surfaces, the polymeric dispersants on the surfaces of the particles repel each other, and thus it becomes difficult to aggregate the particle groups.

Also, the aggregation between the two different kinds of particle groups may be controlled, for example, by controlling the charge amount of the particles that constitute the particle groups. For example, if the charge amount of the two kinds of particle groups is large, it becomes easy to aggregate the particle groups due to an electrostatic force between the particle groups.

Even with respect to the construction that includes the aggregated particles, the processes illustrated in FIGS. 6 and 12 can be performed in the same manner.

In this case, if the voltage of the maximum voltage value is applied, the aggregated particles are released from their aggregated state and move as independent particle groups. Accordingly, the color is changed by applying the voltage of the maximum voltage value.

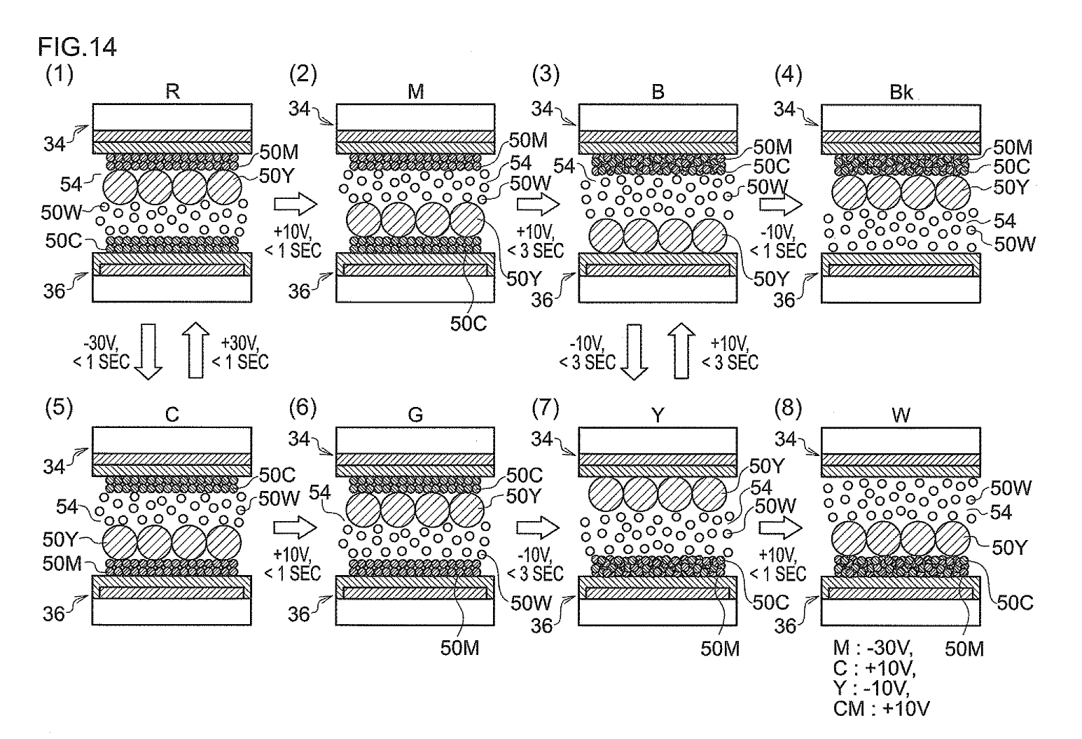

An example of the color change will be described using FIG. 14 in the case where the processes in steps 110 to 116 for displaying the target color are performed after the voltage of the maximum voltage value is applied with respect to a case that includes the aggregated particles.

In an example as illustrated in FIG. 14, it is assumed that a magenta particle group 50M is negatively charged with an absolute value of the movement start voltage of 30V, a cyan particle group 50C is positively charged with an absolute value of the movement start voltage of 10V, and a yellow particle group 50Y is negatively charged with an absolute value of the movement start voltage of 10V. Also, the aggregating particle groups are the particle group 50C and the particle group 50M, and the aggregate 50CM of these particle groups is positively charged with an absolute value of the movement start voltage of 10V. Also, the yellow particle group 50Y has a larger diameter and high movement speed in comparison to other particle groups (the particle group 50M and the particle group 50C) or the aggregate 50CM.

In this case, the charge characteristics of the particle groups included in the display medium 12 are not limited to those as described above. The colors and the charge characteristics of the respective particles may be properly set, and the aggregate may be positively charged as a whole. Also, the applied voltage values as described below are exemplary, are not limited thereto, and may be properly set according to the charge polarity of the respective particles, responsibility, a distance between the electrodes.

FIG. 14(1) shows, as an example, a specified pixel area of the display medium 12 in a red color display (R display) state where the particle group 50M and the particle group 50Y are arranged on the side of the display substrate 34, and the particle group 50C is arranged on the side of the rear substrate 36.

In the display medium 12 in a red color display (R display) state as illustrated in FIG. 14(1), if a voltage of +10V is applied to the pixel electrodes 48 for a necessary time T1 (for example, shorter than one second) for which only the particle group 50Y moves from the side of the display substrate 34 to the side of the rear substrate 36, the particle group 50Y moves to the side of the rear substrate 36. Accordingly, on the side of the display substrate 34, a magenta color by the particle group 50M is displayed (M display) (see FIG. 14(2)).

In the display medium 12 in a magenta color display (M display) state, a voltage of +10V is applied to the pixel electrodes 48 for a necessary time T2 (for example, shorter than three seconds) in which the particle group 50C moves from the side of the rear substrate 36 to the side of the display substrate 34. In this case, the particle group 50C arranged on the side of the rear substrate 36 moves to the side of the display substrate 34, and forms an aggregate 50CM together with the particle group 50M arranged on the display substrate 34 (see FIG. 14(3)). Accordingly, on the side of the display substrate 34, a blue color by the aggregate 50CM of the magenta particle group 50M and the cyan particle group 50C is displayed (B display) (see FIG. 14(3)).

In the display medium 12 in a blue color display (B display) state, a voltage of −10V is applied to the pixel electrodes 48 for a necessary time (for example, shorter than one second) in which the particle group 50Y moves from the side of the rear substrate 36 to the side of the display substrate 34. In this case, the particle group 50Y arranged on the side of the rear substrate 36 moves to the side of the display substrate 34, and a subtractive color mixture of the particle group 50Y and the aggregate 50CM arranged on the display substrate 34 is performed. Accordingly, a black color is displayed (Bk display) (see FIG. 14(4)).

On the other hand, in the display medium 12 in a red color display (R display) state as illustrated in FIG. 14(1), if a voltage of −30V is applied to the pixel electrodes 48 for a necessary time (for example, shorter than one second) in which the particle group 50Y and the particle group 50M move from the side of the display substrate 34 to the side of the rear substrate 36 and the particle group 50C moves from the side of the rear substrate 36 to the side of the display substrate 34, the particle group 50Y and the particle group 50M move to the side of the rear substrate 36 and the particle group 50C moves to the side of the display substrate 34. Accordingly, on the side of the display substrate 34, a cyan color by the particle group 50C is displayed (C display) (see FIG. 14(5)).

In the display medium 12 in a cyan color display (C display) state (see FIG. 14(5)), if a voltage of +30V is applied to the pixel electrodes 48 for a necessary time (for example, shorter than one second) in which the particle group 50Y and the particle group 50M move from the side of the rear substrate 36 to the side of the display substrate 34 and the particle group 50C moves from the side of the display substrate 34 to the side of the rear substrate 36, the particle group 50Y and the particle group 50M move to the side of the display substrate 34 and the particle group 50C moves to the side of the rear substrate 36. Accordingly, on the side of the display substrate 34, a red color by the particle group 50M and the particle group 50Y is displayed (R display) (see FIG. 14(1)).

Also, in the display medium 12 in a cyan color display (C display) state (see FIG. 14(5)), if a voltage of −10V is applied to the pixel electrodes 48 for a necessary time (for example, shorter than one second) in which the particle group 50Y and the particle group 50M move from the side of the display substrate 34 to the side of the rear substrate 36 and only the particle group 50Y moves from the side of the rear substrate 36 to the side of the display substrate 34, the particle group 50Y moves to the side of the display substrate 34. Accordingly, on the side of the display substrate 34, a green color by the particle group 50C and the particle group 50Y is displayed (G display) (see FIG. 14(6)).

In the display medium 12 in a green color display (G display) state (see FIG. 14(6)), a voltage of −10V is applied to the pixel electrodes 48 for a necessary time (for example, shorter than three seconds) in which the particle group 50C moves from the side of the display substrate 34 to the side of the rear substrate 36, the particle group 50C moves to the side of the rear substrate 36, and an aggregate 50CM by the particle group 50C and the particle group 50M is formed. Accordingly, on the side of the display substrate 34, a yellow color by the particle group 50Y is displayed (Y display) (see FIG. 14(7)).

Also, in the display medium 12 in a yellow color display state (see FIG. 14(7)), if a voltage of +10V is applied to the pixel electrodes 48 for a necessary time (for example, shorter than one second) in which the particle group 50Y moves from the side of the display substrate 34 to the side of the rear substrate 36, the particle group 50Y moves to the side of the rear substrate 36. Accordingly, on the side of the display substrate 34, a white color by the particle group 50W is displayed (W display) (see FIG. 14(8)).

Also, in the display medium 12 in a blue color display (B display) state (see FIG. 14(3)), if a voltage of +10V is applied to the pixel electrodes 48 for a necessary time (for example, shorter than three seconds) in which the particle group 50Y moves from the side of the rear substrate 36 to the side of the display substrate 34 and the aggregate 50CM moves from the side of the display substrate 34 to the side of the rear substrate 36, the aggregate 50CM moves to the side of the rear surface 36 and the particle group 50Y moves to the side of the display substrate 34. Accordingly, on the side of the display substrate 34, a yellow color by the particle group 50Y is displayed (Y display) (see FIG. 14(7)).

Further, in the display medium 12 in a yellow color display (Y display) state (see FIG. 14(7)), if a voltage of −10V is applied to the pixel electrodes 48 for a necessary time (for example, shorter than three seconds) in which the particle group 50Y moves from the side of the display substrate 34 to the side of the rear substrate 36 and the aggregate 50CM moves from the side of the rear substrate 36 to the side of the display substrate 34, the aggregate 50CM moves to the side of the display substrate 34 and the particle group 50Y moves to the side of the rear substrate 36. Accordingly, on the side of the display substrate 34, a blue color by the aggregate 50CM is displayed (13 display) (see FIG. 14(3)).

What is claimed is:

1. A display device comprising:
a pair of substrates at least one of which has light transmission;
a display medium which is dispersed between the pair of substrates, and includes a plurality of kinds of particle groups that move in accordance with an electric field formed between the substrates and have different colors and different absolute values of movement voltages required to move;
a voltage applying unit that applies a voltage between the pair of substrates of the display medium;
a first acquisition unit which acquires area information that indicates an area corresponding to a plurality of pixels of an image that is displayed on the display medium as an area in which a displayed color is to be changed on the display medium; and
a control unit that controls the voltage applying unit to apply voltages, which have the same polarity between pixel areas and are equal to or higher than a maximum value among the absolute values of the movement voltages of the plurality of kinds of particle groups, to the respective pixel areas that correspond to the plurality of pixels in the area corresponding to the area information in the display medium when the first acquisition unit acquires the area information.

2. The display device according to claim 1, further comprising a storage unit which pre-stores color information indicating colors that are displayed on the area to be changed to correspond to information that indicates the pixel areas corresponding to the respective pixels on the display medium,
wherein the control unit controls the voltage applying unit to apply the voltages for displaying the colors of the color information that corresponds to the information that indicates the pixel areas to the respective pixel areas after applying the voltages, which have the same polarity between the pixel areas and are equal to or higher than the maximum value, to the respective pixel areas that correspond to the plurality of pixels in the area that corresponds to the area information in the display medium.

3. The display device according to claim 2, further comprising a second acquisition unit that acquires an indication signal for displaying the color of the color information on the area to be changed,
wherein the control unit controls the voltage applying unit to apply the voltages, which have the same polarity between the pixel areas and are equal to or higher than the maximum value, to the respective pixel areas that correspond to the plurality of pixels in the area that corresponds to the area information in the display medium when the first acquisition unit acquires the area information, and
the control unit controls the voltage applying unit to apply the voltages for displaying the colors of the color information that corresponds to the information that indicates the pixel areas to the respective pixel areas when the second acquisition unit acquires the indication signal.

4. A display device comprising:
a pair of substrates at least one of which has light transmission;
a display medium which is dispersed between the pair of substrates, and includes a plurality of kinds of particle groups that move in accordance with an electric field formed between the substrates and have different colors and different absolute values of movement voltages required to move;
a voltage applying unit that applies a voltage between the pair of substrates of the display medium;
a first acquisition unit which acquires area information that indicates an area corresponding to a plurality of pixels of an image that is displayed on the display medium as an area in which a displayed color is to be changed on the display medium;
a storage unit which pre-stores color information indicating colors that are displayed on the area to be changed to correspond to information that indicates the pixel areas corresponding to the respective pixels on the display medium, and stores displayed color information which indicates displayed colors that are displayed on the display medium to correspond to information that indicates the pixel areas corresponding to the respective pixels on the display medium; and
a control unit that controls the voltage applying unit to determine polarities of the voltages, which are equal to or higher than the maximum value and are applied to the respective pixel areas, for the respective pixel areas, based on the displayed color information stored in the storage unit, so that a color, which is displayed on the respective pixel areas that correspond to the plurality of pixels including the pixels having different color information in an area corresponding to the area information in the display medium when the voltages that are equal to or higher than the maximum value among the absolute values of the movement voltages of the plurality of kinds of particle groups are applied to the respective pixel areas, becomes different from the color which had been displayed before the voltages were applied, and to apply the voltages, which have the determined polarities and are equal to or higher than the maximum value, to the respective pixel areas when the first acquisition unit acquires the area information.

5. The display device according to claim 4, wherein the control unit controls the voltage applying unit to apply the voltages for displaying the colors of the color information that corresponds to the information that indicates the pixel areas to the respective pixel areas after applying the voltages, which have the determined polarities and are equal to or higher than the maximum value, to the respective pixel areas that correspond to the plurality of pixels that include the pixels having different color information in the area that corresponds to the area information in the display medium.

6. The display device according to claim 5, further comprising a second acquisition unit that acquires an indication signal for displaying the color of the color information on the area to be changed;
wherein the control unit controls the voltage applying unit to apply the voltages, which have the determined polarities and are equal to or higher than the maximum value, to the respective pixel areas that correspond to the plurality of pixels that include the pixels having different color information in the area that corresponds to the area information in the display medium when the first acquisition unit acquires the area information, and
the control unit controls the voltage applying unit to apply the voltages for displaying the colors of the color information that corresponds to the information that indicates the pixel areas to the respective pixel areas when the second acquisition unit acquires the indication signal.

7. The display device according to claim 1, wherein the area information is trace information which indicates a trace of an indication member that indicates a position on the display medium.

8. The display device according to claim 4, wherein the area information is trace information which indicates a trace of an indication member that indicates a position on the display medium.

9. The display device according to claim 1, wherein the particle groups include a first particle group and a second particle group having different colors and charge polarities, and when the voltage that is equal to or higher than the absolute values of the movement voltages is applied between the substrates, the first particle group and the second particle group move independently, while when the voltage that is lower than the absolute values of the movement voltages is applied between the substrates, the first particle group and the second particle group form an aggregate which is positively or negatively charged and move between the substrates.

10. The display device according to claim 4, wherein the particle groups include a first particle group and a second particle group having different colors and charge polarities, and when the voltage that is equal to or higher than the absolute values of the movement voltages is applied between the substrates, the first particle group and the second particle group move independently, while when the voltage that is lower than the absolute values of the movement voltages is applied between the substrates, the first particle group and the second particle group form an aggregate which is positively or negatively charged and move between the substrates.
